(19) United States
(12) Patent Application Publication
(10) Pub. No.: US 2016/0219895 A1
(43) Pub. Date: Aug. 4, 2016

(54) EDIBLE FAT CONTINUOUS PRODUCT COMPRISING SUCROSE FATTY ACID ESTER AND PARTICULATE ANTI-SPATTERING AGENT

(71) Applicant: CONOPCO, INC., d/b/a UNILEVER, Englewood Cliffs, NJ (US)

(72) Inventors: Arjen BOT, Vlaardingen (NL); Maria Johanna A T HEMELAAR, Rotterdam (NL); Qingguo XU, Baltimore, MD (US); Shiping ZHU, Bedford (GB)

(73) Assignee: Conopco, Inc., d/b/a UNILEVER, Englewood Cliffs, NJ (US)

(21) Appl. No.: 14/917,977

(22) PCT Filed: Jul. 30, 2014
(86) PCT No.: PCT/EP2014/066412

§ 371 Date: Mar. 10, 2016

(30) Foreign Application Priority Data
Sep. 16, 2013 (EP) 13184491.2

(51) Int. Cl. A23D 9/013

(52) U.S. Cl. CPC A23D 9/013

(57) ABSTRACT

The invention is directed to an edible fat continuous product comprising: an overrun from 0 to 500%; and from 7 to 30 wt. % of sucrose fatty acid ester having a HLB value from 2 to 7; and from 0.01 to 5 wt. % of particulate anti-spattering agent.

### TECHNICAL FIELD

The present invention is directed to edible fat continuous products comprising sucrose fatty acid ester and particulate anti-spattering agent. In addition the invention is directed to a method of making said products, as well as to the use for reducing spattering during (shallow) frying.

### BACKGROUND OF THE INVENTION

Edible fat continuous products, such as butter, margarines and liquid oils are well known. These products can be used as frying medium for shallow or deep frying of foods, such as vegetables and meats. In particular, for shallow frying only a thin layer of heated frying medium is used to fry food products.

The fat phase of such frying medium can be a mixture of liquid oil (i.e. fat that is liquid at ambient temperature) and fat which is solid at ambient temperatures. The solid fat, also called structuring fat or hardstock fat, serves to structure the fat phase and improve stability. Ideally the structuring fat has such properties that it melts or dissolves at mouth temperature otherwise the product may have a heavy and/or waxy mouthfeel.

A common problem that is encountered when using such fat continuous products for shallow frying is spattering. Usually a distinction is made between primary spattering and secondary spattering. Primary spattering occurs when a frying medium contains a dispersed water-phase. When heating the frying medium the dispersed water phase can become superheated and evaporate under more or less spattering. With secondary spattering is meant the spattering which occurs when water (e.g. in the form of a water containing food product) is placed into hot frying medium having a temperature above the boiling point of water. As further explained in the Examples, primary and secondary spattering can be evaluated by a SV1 and SV2 score respectively, which runs from 0 (very poor) to 10 (excellent).

Poor spattering behaviour of frying medium (primary or secondary) may lead to the immediate surroundings (e.g. of the frying pan), including any individuals in it, to be exposed to hot oil spatters. This is undesirable as the surrounding surfaces need to be cleaned afterwards, but also since the hot oil spatters may lead to (skin) burns.

Madsen et. al., Emulsifiers Used in Margarine, Low Calorie Spread, Shortening, Bakery Compound and Filing, Fat Science Technology No. 4, 1987; mentions several measures to reduce spattering during frying with margarines. These include the addition of emulsifiers (in particular mono-, and diglycerides, lecithins and citric esters of monoglycerides), salt, milk at high pH, aeration and the addition of egg yolk.

U.S. Pat. No. 3,245,802 discloses a margarine containing debittered soya bean flour to reduce spattering. U.S. Pat. No. 5,338,563 discloses a fat-continuous emulsion, with a fat content of less than 50%, which comprises lecithin that is incorporated in uncrystallised fat to reduce spattering.

WO2005/058067 discloses a water-in-oil emulsion containing powdered vegetable matter to reduce spattering. In particular it is shown that use of soy flour does not always lead to satisfactory SV2 scores.

When combining features from the prior art, it was observed that the secondary spattering behaviour of frying media even when aerated and supplemented with particulate anti-spattering agents, such as salt or debittered soy bean flour is still unsatisfactory. It was observed that this is especially the case for frying media that have little or no water-phase.

It is therefore an object of the present invention to provide an edible fat continuous product comprising particulate anti-spattering agents, preferably having little or no water-phase, having good spattering performance in shallow frying and more preferably having an improved secondary spattering performance.

It is a further object of the present invention to provide an edible aerated fat continuous product comprising particulate anti-spattering agents, preferably having little or no water-phase, having good spattering performance in shallow frying and more preferably having an improved secondary spattering performance.

### SUMMARY OF THE INVENTION

It was found that one or more of these objectives are met by the addition of sucrose fatty acid ester (SFAE) having a HLB value (i.e. Hydrophilic-Lipophilic Balance) of 2 to 7 to fat continuous frying medium further comprising particulate anti-spattering agent. In particular, it was found that the SFAE according to the invention needs to be added in a relatively high amount to be effective.

Therefore in a first aspect the invention provides an edible fat continuous product comprising:
an overrun from 0 to 500%; and
from 7 to 30 wt. % of sucrose fatty acid ester having a HLB value from 2 to 7; and
from 0.01 to 5 wt. % of particulate anti-spattering agent.

It was observed that the spattering behaviour (in particular the secondary spattering) during use as shallow frying medium of the, optionally aerated, product according to the invention was improved compared to:
fat continuous compositions having 3 wt. % SFAE, such as can be found in the prior art; or
a similar product with sucrose fatty acid ester according to the invention, but without any edible particulate anti-spattering agent according to the invention; or.
a similar product with monoglyceride instead of SFAE; or
a similar product with lecithin instead of SFAE.

In a second aspect the present invention provides a method for the preparation of an edible product according to the invention, comprising the steps:

a) providing a liquid mixture of fat; and from 7 to 30 wt. % of sucrose fatty acid ester having a HLB value from 2 to 7; and
b) optionally aerating the liquid mixture of step a) to an overrun from 0 to 500%; wherein 0.01 to 5 wt. % of the particulate anti-spattering agent can be added before, during or after step a) or b) in whole or in parts.

In a third aspect the present invention provides use of a product according to the invention for reducing spattering during shallow frying and preferably for reducing secondary spattering.

### DETAILED DESCRIPTION

Weight percentage (wt. %) is based on the total weight of the product unless otherwise stated. It will be appreciated that the total weight amount of ingredients will not exceed 100 wt. % based on total weight of the product.

The terms ‘fat’ and ‘oil’ are used interchangeably. Where applicable the prefix ‘liquid’ or ‘solid’ is added to indicate if the fat or oil is liquid or solid at ambient temperature as understood by the person skilled in the art. Ambient temperature is considered to be a temperature of about 20 degrees Celsius. Hardstock fat (a.k.a. structuring fat) refers to a fat that is solid at ambient temperature as understood by the person skilled in the art.

The terms ‘triacylglycerols’, ‘TAGs’, and ‘triglycerides’ are used interchangeably. The terms sucrose fatty acid ester and its abbreviation SFAE are used interchangeably. The terms ‘particulate’ and ‘particle’ are used interchangeably.

The terms ‘improved spattering (behaviour)’, ‘reduced spattering’ are used interchangeably to indicate less spattering of the product according to the invention when used as shallow frying medium. The spattering scores SV1 and SV2 are as defined herein below and are indicative of spattering behaviour. Higher SV1 or SV2 score indicates improved primary or secondary spattering respectively. Preferably the products according to the invention, in particular of the top layer of the product have a SV2 score of at least 5, more preferred at least 7, even more preferred at least 8 and still even more preferred at least 9.

The top layer of the product is the upper third volume of the product when the product is left to stand in a typical container (e.g. a jar) for some time (e.g. one hour).

### Edible Fat

Edible fat typically contains 80 wt. % or more of triacylglycerols (TAGs). The TAGs are esters of glycerol and three fatty acids. The fatty acid (moieties) of the TAGs may vary in length (a.k.a. carbon number) and may be saturated, monounsaturated or polyunsaturated.

### Liquid Oil

The liquid oil of the fat continuous product according to the invention may be liquid oil of a single type (e.g. sunflower oil) or a mixture of different oils. The liquid oil may be of marine, animal and/or vegetable origin. An example of marine oil is fish oil. Examples of animal oils are (e.g. olein fractions) of dairy fat and lard. Examples of vegetable oils are (e.g. olein fractions of) coconut oil, palm kernel oil, palm oil, soybean oil, sunflower oil, linseed oil, rapeseed oil, corn oil, olive, algae oil, oil safflower oil, cotton seed oil and poppy seed oil. For the purpose of this invention algae oil is considered vegetable oil.

Preferably at least 50 wt. % of the liquid oil, more preferably at least 70 wt. %, even more preferably at least 90 wt. %, still even more preferably at least 95 wt. %, based on total amount of liquid oil and still even more preferably essentially all of the liquid oil is of vegetable origin, dairy origin or a combination thereof.

Preferred liquid vegetable oil is soybean oil, sunflower oil, linseed oil, low erucic rapeseed oil (Canola), corn oil (maize oil), olive oil, algae oil and mixtures thereof.

Preferably the fat continuous product according to the invention comprises at least 75 wt. %, more preferably at least 85 wt. % and still even more preferably at least 90 wt. % of liquid oil.

### Hardstock Fat

Preferably the edible fat continuous product according to the invention comprises at most 25 wt. %, more preferably at most 10 wt. %, even more preferably at most 5 wt. %, even more preferably at most 2 wt. % and still even more preferably essentially no hardstock fat (i.e. essentially all of the fat is liquid oil).

When present, preferably the hardstock fat comprises or essentially consists of palm oil, palm kernel oil, coconut oil, dairy fat or any combination thereof. The hardstock fat may be hydrogenated, fractionated and/or interesterified (both inter and intra).

When present, the hardstock fat preferably has a solid fat content (i.e. N-line) N10 from 50 to 100%; a solid fat content N20 from 26 to 95% and a solid fat content N35 of 0 to 60%.

### HLB Value

HLB values are a well-known classification of surfactants or mixtures of surfactants, based on the ratio of the hydrophilic and hydrophic portions of the surfactant molecules. The HLB value is given by the equation HLB value=20*Mₕ/M, where Mₕ is the molecular mass of the hydrophilic part of the molecule and M is the molecular mass of the whole molecule thus giving a value on an arbitrary scale of 0 to 20. For fatty acid esters, HLB value=20 (1−S/A) where

S=Saponification value
A=Acid number of the fatty acid

Therefore an HLB value of 0 corresponds to a completely hydrophobic molecule and an HLB value of 20 corresponds to a completely hydrophilic molecule. Typical HLB values are generally associated with the following functionality:

0 to 3 an anti-foaming agent
4 to 6 a water-in-oil emulsifier
7 to 9 a wetting agent
8 to 18 an oil-in-water emulsifier
13 to 15 a detergent
10 to 18 a solubiliser or a hydrotrope

### Sucrose Fatty Acid Ester

Sucrose fatty acid esters (SFAEs) according to the present invention are compounds which are esters of sucrose and one or more fatty acids. Sucrose esters of fatty acids can be obtained by esterifying one or more of the hydroxyl group of a sucrose molecule with fatty acids. As sucrose has 8 hydroxyl groups, the maximum number of fatty acids that is esterified to one sucrose molecule is eight, to form sucrose octa fatty acid ester. Due to the production process of SFAEs (see EP 1 813 622 A1), a sample of SFAEs may comprise a mixture of mono-, di-, tri-, and multi fatty acid esters. In a commercial sample the degree of esterification generally has a distribution, and is usually characterized by an average degree of substitution.

The fatty acids (a.k.a. the fatty acid moieties) of the SFAE may vary in length (typically expressed as in the fatty acid carbon number) and may be saturated, monounsaturated or polyunsaturated. Preferably the fatty acid moieties of the SFAE comprises at least 70 wt. %, based on the total weight of said moieties, of lauric acid (C12:0), myristic acid (C14:0), palmitic acid (C16:0), stearic acid (C18:0) or mixtures thereof; more preferably of palmitic acid, stearic acid or mixtures thereof; and even more preferably of stearic acid.

The SFAE according to the present invention can be a mixture of different types of SFAE. For example, it may be a mixture of SFAEs having a different degree of esterification with fatty acids (e.g. sucrose penta fatty acid ester, sucrose mono fatty acid ester) and/or of SFAEs which differ in the types of esterified fatty acid moieties.

The sucrose fatty acid ester according to the invention is characterized by having a HLB value from 2 to 7, preferably from 2 to 5 and more preferably from 2 to 4. Said HLB values refer to the average HLB value of the SFAE in case mixtures of SFAEs are used. It was observed that optionally aerated fat continuous products comprising SFAE with an (average) HLB value above or below the range according the invention have poorer spattering behaviour when used as shallow frying medium. In addition said reduced spattering behaviour was observed especially for the top layer of aerated products.

Preferably the SFAE according to the invention comprises from 5 to 45 wt. %, preferably from 15 to 35 wt. %, more preferably from 16 to 32 wt. % and even more preferably from 17 to 25 wt. %, based on the total weight of the sucrose fatty acid ester, of sucrose mono-fatty acid ester.

The fat continuous product according to the invention comprises from 7 to 30 wt. %, preferably from 7.5 to 20 wt. %, more preferably from 7.75 to 15 wt. %, even more preferably from 8 to 11 wt. % and still even more preferably from 8.5 to 10 wt. % of SFAE according to the invention. It was observed that use of the SFAE in an amount not according to the invention, such as 3 wt. % leads to poor spattering behaviour when used as shallow frying medium. In addition it can lead to poor anti-spattering behaviour of the top layer of the aerated product.

Depending on the type and amount of SFAE used, part of the SFAE may sediment (form residue) at ambient conditions and/or during typical storage conditions such as in the fridge. The amount of SFAE in the fat continuous product according to the invention includes the dissolved and the sediment SFAE. The sediment SFAE is not part of the particulate anti-spattering agent.

(Mixtures of) SFAEs in a wide variety of (average) HLB value are commercially available. For example, Mitsubishi-Kagaku Foods Corporation (Tokyo, Japan) supplies amongst others L195 (sucrose laurate), S070 (sucrose stearate), S170, S270, S370, S570, S770, S970, S1670, P170 (sucrose palmitate), O-170 (sucrose oleate) and B-370 (sucrose behenate). Generally the name of the various types of commercial samples is given by the main fatty acid and the HLB value for the sucrose esters. For example, L195 contains about 95% lauric acid and another 5% are palmitic acid, stearic acid, etc, and its HLB value equals to 1. S070, S170, S270, S370, S570 are sucrose stearic acid esters with 70% stearic acid and HLB values ranging from <1, 1, 2, 3 and 5, respectively. Its HLB value increases with the increasing of the amount of mono- or di-esters. For example S170 has very little mono ester therefore its HLB value is 1. For S570, its HLB value is 5 as it contains about 30% mono ester. Preferred commercially available SFAEs for in use in the present invention are S370, S570, S770 or mixtures thereof, more preferably S370, S570 or mixtures thereof and even more preferably is S370.

Another supplier of suitable sucrose fatty acid esters is Sisterna BV (Roosendaal, The Netherlands). Sisterna uses a similar naming convention as Mitsubishi-Kagaku Foods Corporation.

### Particulate Anti-Spattering Agent

The fat continuous product according to the invention comprises from 0.01 to 5 wt. %, preferably from 0.10 to 4 wt. %, more preferably from 0.5 to 3.5 wt. %, even more preferably from 1.0 to 3.0 wt. % and still even more preferably from 1.5 to 2.5 wt. % of total particulate anti-spattering agent.

With the term ‘particulate’ is meant that the anti-spattering agent is present in the fat continuous product according to the invention at least partly in the form of particulates. Preferably at least 70 wt. %, more preferably at least 80 wt. %, even more preferably at least 90 wt. %, based on the total weight of the anti-spattering agent, and still even more preferably essentially all of the anti-spattering agent is present in the form of particulates.

Said particulates are present at ambient storage conditions, but also when the product is heated, such as to 70 degrees Celsius. For example SFAE may form sediment at ambient conditions, in particular when high concentrations are used. However, SFAE dissolves in liquid oil when the oil is sufficiently heated. Thus SFAE are not considered part of the particulate anti-spattering agent according to the invention.

An example of a simple test to see if an anti-spattering agent forms particulates in liquid oil according to the invention is to add them to liquid oil, such as liquid sunflower oil, and see whether particles of said agent can be separated or concentrated from (the optionally heated oil such as at 70 degrees Celsius) by sedimentation or filtration. However, whether anti-spattering agents do, or do not, dissolve (i.e. form particulates) in (heated) liquid oil, water and/or an emulsion thereof typically is part of the common knowledge and known to the skilled person.

The anti-spattering particulate agent may be of a single type of anti-spattering agent (e.g. soy flour) or of a mixture of different types of anti-spattering agents (e.g. salt and soy flour).

Preferably the anti-spattering particulate agent has a (average) volume weighted mean diameter from 10 nm to 10 mm, more preferably from 20 nm to 5 mm, even more preferably from 50 nm to 1 mm, still even more preferably from 500 nm to 0.75 mm and still even more preferably from 1 μm to 0.5 mm.

Salt, such as sodium chloride, is a known anti-spattering which has a low solubility and forms oil insoluble particulates. Preferably the fat continuous product according to the invention comprises from 1 to 2.5 wt %, more preferably from 1.2 to 1.8 wt. % of salt particulates. Preferably the salt is selected from potassium salts, sodium salts, choline salts, ammonium salts, calcium salts and combinations thereof; and more preferably is selected from potassium chloride, sodium chloride, choline choride, and combinations thereof.

Porous powdered vegetable matter is another known anti-spattering agent, such as described in WO 2005/058067 and WO2008/074593. The vegetable matter preferably consists of one or more substances selected from the group consisting of fruits (e. g. dried olives), nuts (e. g. almond, walnut, cashew nut, ground nut, pine tree nut), seeds (e. g. sunflower seed, linseed), beans (e. g. Soybeans, such as soy flour), kernels and pits (e. g. olive kernels) and cellulose; more preferably consists of milled kernels of olives, milled seeds or beans such as sunflower seed, linseed and soybeans.

When the used porous powdered vegetable matter contains oil or fat, it may be subjected to a defatting treatment before the milling step in order to impart to the powder the desired anti-spattering properties. Extraction may be done using any known extracting method and any extractant suitable for extracting oil, for example organic solvent or a liquified gas such as liquified carbon dioxide. Extraction with hexane delivers a suitable defatting (or deoiling) result. For substances having only a low oil or fat content defatting may appear to be less necessary, but nevertheless the extraction may enhance anti-spattering behaviour.

Preferably the particulate anti-spattering agent according to the invention comprises or essentially consists of salt, porous powdered vegetable matter or a combination thereof; and more preferably of sodium chloride, potassium chloride, soy flour or a combination thereof.

### Aeration and Overrun

The term ‘aerated’ means that gas has been intentionally incorporated into a product, for example by mechanical means. The gas can be any gas, but is preferably, in the context of food products, a food-grade gas such as air, nitrogen, nitrous oxide, or carbon dioxide. Hence the term ‘aeration’ is not limited to aeration using air, and encompasses the ‘gasification’ with other gases as well. The extent of aeration is measured in terms of ‘overrun’ (with unit ‘%’), which is defined as:

$$overrun = \frac{\begin{matrix}volume of aerated product - \\ volume of initial mix\end{matrix}}{Volume of initial mix} \times 100 \% \qquad ( 1 )$$

where the volumes refer to the volumes of aerated product and unaerated initial mix (from which the aerated product is made). Overrun is measured at atmospheric pressure.

The overrun of an aerated product and the volume fraction of gas in the aerated product generally relate in the following way:

volume fraction gas (in %)=overrun/(100%+overrun)

The fat continuous product according to the invention has an overrun from 0 to 500%. Preferably the fat continuous product according to the invention has an overrun from 10 to 400%, more preferably from 20 to 300%, even more preferably from 50 to 200% and still even more preferably from 75 to 150%.

The advantage of having a relatively high overrun is that the spattering behaviour of the fat continuous product, in particular of the top layer of the product is further improved, especially upon storage. An important advantage of this is that the consumer need not shake the product before use to obtain satisfactory spattering behaviour. Additionally a relatively high overrun also helps to reduce or stop the tendency of gas bubbles of creaming.

Aeration of the product may be done by any method commonly known for aeration, such as an aerolatte, kenwood mixer, a BA Mixer, an Oakes mixer, a Mondomixer, or an Ultra-turrax mixer. Mixing can also be performed using in line aeration equipment, such as a pin stirrer (like a C-unit) with nitrogen or other gas inlet.

The mixing power (and hence the shear stress applied during the aeration) influences the bubble size and the bubble size distribution. The more shear is applied, the smaller the average bubble size, and the more homogeneous the bubble size distribution. Preferably, the aeration is done in such a way that at least 50% of the volume of the gas in the aerated fat continuous product according to the invention is made up of gas bubbles having a volume based equivalent diameter of at most 100 micrometer, more preferably of at most 70 micrometer, even more preferably of at most 50 micrometer and still even more preferably of at most 40 micrometer. In the context of the present invention, the ‘volume based equivalent diameter’ of a gas bubble is the diameter of a sphere having the same volume as the relevant gas bubble, as the gas bubbles in a product may not be perfect spheres.

### Other Ingredients

The fat continuous product according to the invention may comprise other ingredients, such as flavours (e.g. in addition to salt), colouring, herbs and spices (e.g. in addition to the powdered vegetable matter), emulsifiers (i.e. in addition to SFAE, such as monoglycerides) and anti-oxidants. It will be appreciated that such one or more other ingredients adhere to the specifications according to the invention. For example such other ingredients should be edible and the amount of particulate anti-spattering agent should be from 0.01 to 5 wt. %.

Preferably the edible fat continuous product according to the invention comprises at most 15 wt. %, more preferably at most 5 wt. %, even more preferably at most 2 wt. % of a water-phase and still even more preferably comprises essentially no water-phase. In particular the invention improves the anti-spattering behaviour of, optionally aerated, fat continuous products having a small amount of water-phase. With water-phase is indicated water which is present in the form of dispersed water droplets.

### Hydrophobins

Hydrophobins are a well-defined class of proteins (Wessels, 1997, Advances in Microbial Physiology 38: 1-45; Wosten, 2001, Annual Reviews of Microbiology 55: 625-646) that are capable of self-assembly at a hydrophobic/hydrophilic interface, and having a conserved sequence:

Xₙ-C-X₅₋₉-C-C-X₁₁₋₃₉-C-X₈₋₂₃-C-X₅₋₉-C-C-X₆₋₁₈-C-Xₘ (1)

where X represents any amino acid, and n and m independently represent an integer. Typically, a hydrophobin has a length of up to 125 amino acids. The cysteine residues (C) in the conserved sequence are part of disulphide bridges. In the context of the present invention, the term hydrophobin has a wider meaning to include functionally equivalent proteins still displaying the characteristic of self-assembly at a hydrophobic-hydrophilic interface resulting in a protein film, such as proteins comprising the sequence:

Xₙ-C-X₁₋₅₀-C-X₀₋₅-C-X₁₋₁₀₀-C-X₁₋₁₀₀-C-X₁₋₅₀-C-X₀₋₅-C-X₁₋₅₀-C-Xₘ (2)

or parts thereof still displaying the characteristic of self-assembly at a hydrophobic-hydrophilic interface resulting in a protein film. Said self-assembly can be detected by adsorbing the protein to Teflon and using Circular Dichroism to establish the presence of a secondary structure (in general, α-helix) (De Vocht et al., 1998, Biophys. J. 74: 2059-68). The formation of a film can be established by incubating a Teflon sheet in the protein solution followed by at least three washes with water or buffer (Wosten et al., 1994, Embo. J. 13: 5848-54). The protein film can be visualised by any suitable method, such as labeling with a fluorescent marker or by the use of fluorescent antibodies, as is well established in the art. m and n typically have values ranging from 0 to 2000, but more usually m and n in total are less than 100 or 200. The definition of hydrophobin in the context of the present invention includes fusion proteins of a hydrophobin and another polypeptide as well as conjugates of hydrophobin and other molecules such as polysaccharides.

Preferably the fat continuous product according to the invention comprises less than 0.01 wt. % of hydrophobin, more preferably at most 0.005 wt. % of hydrophobin and even more preferably comprises (essentially) no hydrophobin.

### Product Format

In one preferred embodiment the fat continuous product may be a free flowing (pourable) product. In case of a free flowing product, the product according to the invention preferably has a Bostwick value at 15 degrees Celsius of at least 5, more preferably of at least 10 and even more preferably of at least 15.

In an alternative preferred embodiment the product has a consistency such that it is spoonable. In this case the product preferably has a Stevens value at 5 degrees Celsius from 25 to 250, preferably from 35 to 200, more preferably from 35 to 175 and even more preferably from 50 to 100.

The Stevens value according to the invention is measured with a Stevens penetrometer (Brookfield LFRA Texture Analyser (LFRA 1500), ex Brookfield Engineering Labs, UK) equipped with a typical mayonnaise grid as probe (as described in WO0234071). The probe is pushed into the product at a speed of 1 mm/s, for a distance of 29 mm. The force required is read from the digital display and is expressed in grams. The Stevens value is measured at ambient temperature.

### Packaging

The products may be packaged in any form of container. Preferred are plastic bottles with a detachable closure and/or pouring spout, although tubs are also contemplated. The bottle may be rigid or deformable. A deformable bottle allows the bottle to be squeezed to aid dispensing. Preferably the container is clear enough that the liquid, with any visual cues therein, is visible from the outside. Clear bottles can be formed from PET, such as polyethylene or clarified polypropylene. The bottle may be provided with one or more labels and/or with a shrink wrap sleeve which preferably is at least partially transparent, and more preferably 50% of the area of the sleeve and/or label is transparent. The adhesive used for any transparent label should preferably not adversely affect the transparency.

### Method for Preparation of the Product

In a second aspect the present invention provides a method for preparation of an edible product according to the invention, comprising the steps:

a) providing a liquid mixture of fat; and sucrose fatty acid ester having a HLB value from 2 to 7 at a concentration from 7 to 30 wt. %; and
b) optionally aerating the liquid mixture of step a) to an overrun from 0 to 500%; wherein the 0.01 to 5 wt. % of the particulate anti-spattering agent can be added before, during or after step a) or b); and in whole or in parts.

In step a) a liquid mixture is provided of the sucrose fatty acid ester and fat. The temperature of the mixture is such that the SFAE and the fat melts (e.g. when hardstock fat is present) and can be mixed easily. The temperature during mixing at step a) preferably is from 60° C. to 90° C., more preferably from 65° C. to 85° C. and even more preferably from 65° C. to 80° C.

The optional aeration at step b) is done at such temperature that the mixture from step a) is liquid, hence preferably the mixing in step b) is done at the same preferred range as in step a): preferably ranging from 60° C. to 90° C., preferably from 65° C. to 85° C., preferably from 65° C. to 80° C. In case it is desired that the fat continuous product has a no overrun, step b can be skipped.

The particulate anti-spattering agent is added to the one or more other ingredients before, during and/or after step a) and/or optional step b). For example the particulate anti-spattering agent can be added in whole or in parts (e.g. in several portions). For example, part of the particulate can be added to the liquid mixture of SFAE and fat at step a); and part can be post-dosed to the optionally aerated product (i.e. after step b) and mixed in). Preferably the particulate anti-spattering agent is homogenously dispersed over the optionally aerated product.

Preferred aspects of the product disclosed in here in the context of the first aspect of the invention are also applicable to the second aspect of the invention, mutatis mutandis.

### Use

It was observed that the optionally aerated product according to the invention can be used to reduce spattering during shallow frying and preferably to reduce secondary spattering. In addition the spattering behaviour of the top layer of aerated fat continuous products could be improved.

Therefore the invention also relates in a third aspect to the use of a product according to the invention to improve the spattering behaviour and preferably to improve the secondary spattering during shallow frying.

Preferred aspects of the product disclosed in here in the context of the first and/or second aspect of the invention are also applicable to the third aspect of the invention, mutatis mutandis.

Various modifications of the described modes for carrying out the invention which are apparent to those skilled in the relevant fields are intended to be within the scope of the following claims.

The invention is now illustrated by the following non limiting examples.

### EXAMPLES

### Primary and Secondary Spattering Tests

Primary spattering (SV1) is assessed under standardised conditions in which an amount of a product is heated in a glass dish and the amount of fat spattered onto a sheet of paper held above the dish is assessed after the water content of the food product has been evaporated by heating.

Secondary spattering (SV2) is assessed under standardised conditions in which the amount of fat spattered onto a sheet of paper held above the dish is assessed after injection of a quantity of water into the dish.

In assessment of both primary and secondary spattering scores, 25 gram of product is heated in a 15 cm diameter glass bowl on an electric plate to about 205° C. The fat that spatters out is caught on a sheet of paper situated at 25 cm above the pan (SV1 test). Subsequently a quantity of 10 millilitre of water is poured into the bowl and again the fat that spatters out of the glass bowl is caught on a sheet of paper situated above the pan (SV2 test).

The images on the paper sheets as obtained are compared with a set of standard pictures, numbered 0-10, whereby the number of the best resembling picture is recorded as the spattering score. A score of 10 indicates no spattering and a score of 0 indicates very high spattering. The standard scoring method is as indicated in table 1.

TABLE 1
Standard scoring table for spattering values SV1 and SV2

| Score | Comments |
|---|---|
| 10 | Excellent |
| 8 | Good |
| 6 | Passable |
| 4 | Unsatisfactory for SV1, almost passable for SV2 |
| 2 | Very poor |

Typical results for household margarines (˜80 wt % fat) are 8.5 for primary spattering (SV1) and 4.6 for secondary spattering (SV2) under the conditions of the above mentioned test.

### Materials and Methodology

### Raw Materials Used

Sucrose fatty acid esters used, all supplied by Mitsubishi-Kagaku Foods Corporation (Tokyo, Japan), all analytical data obtained from supplier:
Ryoto S070: HLB value <1, about 100% di-, tri- and polyester;
Ryoto S170: HLB value about 1, about 100% di-, tri- and polyester;
Ryoto S270: HLB value about 2, about 10% mono-ester, and about 90% di-, tri- and polyester;
Ryoto S370: HLB value about 3, about 20% mono-ester, and about 80% di-, tri- and polyester;
Ryoto S570: HLB value about 5, about 30% mono-ester, and about 70% di-, tri- and polyester;
Ryoto S770: HLB value about 7, about 40% mono-ester, and about 60% di-, tri- and polyester
Ryoto S970: HLB value about 9, about 50% mono-ester, and about 50% di-, tri- and polyester

All these esters contain at least 70% of the fatty acids is stearic acid.

Typical ester analysis based on HLB value:

HLB value 1: ˜1% mono, ˜4% di, ˜7% tri, ˜13% tetra, ˜28% penta, ˜24% hexa, ˜23% hepta and higher.

HLB value 3: ˜18% mono, ˜32% di, ˜29% tri, ˜16% tetra, ˜5% penta and higher.

HLB value 7: ˜37% mono, ˜45% di, ˜16% tri, ˜2% tetra and higher.

### Other Raw Materials

Sunflower oil, supplier Cargill (Amsterdam, Netherlands);
Coconut oil, supplier Brenntag Eurochem GmbH (Duisburg, Germany);
Cocoa butter, supplier Barry Callebaut (Zundert, Netherlands);
Anhydrous Milk Fat (butter oil), supplier FrieslandCampina (Amersfoort, Netherlands)
Butter oil, melting point 15° C., supplier FrieslandCampina (Amersfoort, Netherlands)
Monoglyceride: Dimodan HP, supplier Danisco (Copenhagen, Denmark);
Lecithin: soya bean oil lecithin, Bolec ZT®, supplier RF Solutions ('s-Hertogenbosch, Netherlands);
Soy flour: Nutrisoy, supplier ADM (Decatur, Ill., USA)
Sodium Chloride: Akzo (Hengelo, Netherlands)
Potassium Chloride: Merck (Darmstadt, Germany)

In general, it was found that in the products according to the invention, further improvements in the spattering behaviour could be made by providing sufficient overrun. This is particular the case for the spattering behaviour of the top layer of aerated products. As shown below, the achieved overrun may depend, besides specific processing conditions, on the type and amount of the SFAE used.

### Example 1

### Influence of HLB Value of SFAE and Oil Type on Foaming of Oil

SFAE was mixed with sunflower oil (at a concentration of 10 wt %) and dissolved by heating to 70° C. The mix was then equilibrated for 1 hour at 70° C. Aeration was done using a hand held whisk (Krups) at the maximum speed for 5 minutes at 70° C. The overrun achieved and the amount of formed is shown in Table 2.

TABLE 2
The overrun of different emulsifiers in sunflower oil,
cocoa butter, or coconut oil at 10 wt % concentration.

| Emulsifier | S070 | S170 | S270 | S370 | S570 | S770 | S970 |
|---|---|---|---|---|---|---|---|
| HLB value | <1 | 1 | 2 | 3 | 5 | 1 | 9 |

Sunflower oil

| | | | | | | | |
|---|---|---|---|---|---|---|---|
| Residue [wt | 0 | 0 | 1.66 | 2.91 | 7.57 | ~10 | n/a * |
| %] at 70° C. | | | | | | | |
| overrun [%] | 8 | 45 | 180 | 290 | 100 | ~0 | n/a |

Cocoa butter

| | | | | | | | |
|---|---|---|---|---|---|---|---|
| Residue [wt | n/a | 0 | 8 | 1.2 | 5.0 | 8.0 | 8.5 |
| %] at 70° C. | | | | | | | |
| overrun [%] | n/a | 5 | 186 | 211 | 139 | 17 | 1 |

Coconut oil

| | | | | | | | |
|---|---|---|---|---|---|---|---|
| Residue [wt | n/a | 0 | 1.0 | 1.6 | 5.0 | n/a | 8.0 |
| %] at 70° C. | | | | | | | |
| overrun [%] | n/a | 0 | 82 | 198 | 48 | n/a | 0 |

* ‘n/a’ is not measured

As shown in Table 2 the overrun achieved can depend on the HLB value of the SFAE and the type of oil used.

### Example 2

### Influence of Concentration of SFAE on Aeration of Oil

The concentration of sucrose fatty acid ester Ryoto S370 was varied in order to investigate the influence on the overrun of aerated oil. The following procedure was applied.
1. 50 g samples with different concentrations of S370 in sunflower oil were heated at 70° C. for 2 hours;
2. The samples were directly aerated at 70° C. using Ultra Turrax T 25 high shear mixer (supplier: IKA®-Werke GmbH & Co. KG, Staufen, Germany), during two minutes at a speed of 13,500 min⁻¹.
3. The experiments were done in triplicate.

The following results were obtained (average of the triplicates) for a batch aeration operation:

TABLE 3
The overrun in sunflower oil, as function of concentration
of sucrose fatty acid ester Ryoto S370.

| Ryoto S370 (wt. %) | Overrun (%) |
|---|---|
| 2 | 4.5 |
| 5 | 22.9 |
| 10 | 36.9 |
| 15 | 62.6 |
| 20 | 82.6 |
| 25 | 92.8 |
| 30 | 91.0 |

This shows that in this test the overrun increases until a maximum is achieved at 25 wt %.

### Example 3

### Influence of Salt, Lecithin and Overrun on Secondary Spattering

Fat continuous products were made using sunflower oil, SFAE (9 wt. %; Ryoto S370), salt, lecithin as shown in the table below. The amount of salt, lecithin and overrun was varied. The products were made according to the following procedure.
1. A stock solution of 10 wt. % Ryoto S370 in sunflower oil was made by heating at 70° C. for 2 hours;
2. 100 g of the dissolved stock solution was optionally mixed with an amount of salt and/or lecithin as indicated in table 4.
3. The samples were directly aerated at 70° C. using Ultra Turrax T 25 high shear mixer (supplier: IKA®-Werke GmbH & Co. KG, Staufen, Germany) at a speed of 13.500 min⁻¹ until the desired overrun was achieved as indicated in table 4.
4. To determine the SV2 score of a product, a sample was taken from the top layer of the product and analysed in the spattering test (in duplicate).
   SV1 is 10 for all samples, as expected since no water was present in the composition. The results for SV2 are listed in Table 4.

TABLE 4
composition and SV2 scores of products of Example 3,
the amount of salt and lecithin are in wt. %.

overrun

| NaCl | lecithin | 0% | 10% | 50% | 100% |
|---|---|---|---|---|---|
| — | — | 0 | 4.3 | 3.5 | 2 |
| — | 0.5 | 0 | 1.5 | 2 | 2 |
| 1 | — | 0 | 7.5 | 8 | 7 |
| 1 | 0.5 | 0 | 8.5 | 8.5 | 8.5 |

These results show that the combination of salt and SFAE provides superior SV2 scores. Further addition of lecithin resulted in even superior SV2 scores. However, SFAE alone or in combination with lecithin did not lead to adequate SV2 scores.

### Example 4

### Influence of NaCl and KCl on Secondary Spattering

Fat continuous products were made and tested (i.e. sample of the top layer) according the protocol used in Example 3. The products comprised SFAE (9 wt. %; Ryoto S370) and sunflower oil. The type and amount of salt was varied (Table 5). All products were aerated to an overrun of 100%.

TABLE 5
Composition and SV2 scores of the products of Example 4, the
amount of sodium chloride and potassium chloride are in wt. %.

| NaCl | KCl | SV2 |
|---|---|---|
| — | — | 3 |
| 0.2 | — | 2.5 |
| 1 | — | 7 |
| 2 | — | 7.5 |
| — | 1 | 7 |

These results show that potassium chloride works equally well as sodium chloride.

### Example 5

### Influence of Soy Flour on Secondary Spattering

Fat continuous products were made and tested (i.e. sample of the top layer) according the protocol used in Example 3. The products comprised SFAE (9 wt. %; Ryoto S370) and sunflower oil. The products were aerated and soy flour was added in amounts as shown in Table 6.

TABLE 6
Composition and SV2 scores of the products of
Example 5, the amounts of soy flour is in wt. %.

Overrun

| soy flour | 0% | 10% | 50% | 100% |
|---|---|---|---|---|
| — | 0 | 4 | 4 | 3 |
| 0.5 | 7 | 8 | 7 | 8 |
| 2 | 5 | 8.5 | 9.5 | 9 |

These results show that also the combination of SFAE and soy flour as particulate anti-spattering agent results in superior SV2 scores.

### Example 6

### Influence of Monoglyceride on SV2

Aerated oil continuous products were prepared comprising 3 wt. % monoglyceride (Dimodan HP), 1.5 wt. % salt and a fat blend comprising rapeseed oil: butter oil 65:29, and a trace amount of Beta-carotene. The fat continuous compositions were made by mixing the ingredients at 70 degrees Celsius and aerating (Kenwood Chef Classic Food Mixer (4.6 L) KM336 (Kenwood Co., Japan) for 2.5 min). To provide overrun of 150% aeration at temperature of 5 degrees Celsius was required. A sample of the upper layer of the fat continuous products were tested according to Example 3 (Table 7)

TABLE 7
Composition and SV2 scores of the products of Example 6,
the amounts of monoglyceride (MG) and NaCl are in wt. %.

overrun

| MG | NaCl | 5% | 150% |
|---|---|---|---|
| 3.0 | 1.5 | 0 | 0 |

### Example 7

### SV2 Spattering of Non-Aerated Fat Continuous Products

Fat continuous products were made with a composition according to Table 8. In particular ingredients were mixed at 70 degrees Celsius. 25 gram was prepared of each composition, and used to test SV2. The compositions were not aerated.

TABLE 8
Composition and SV2 scores of the products of Example 7,
the amounts of monoglyceride (MG), SFAE and salt are in wt. %.

Fat phase

| MG | SFAE | Salt | Sunflower oil | Butter oil |
|---|---|---|---|---|
| — | — | 1.5 | 0 | 0 |
| 3.0 | — | 1.5 | 0 | 0 |
| — | 9.0 | 1.5 | 8.25 | 6.75 |

This Experiment shows that even without aeration the combination of SFAE and salt leads to superior SV2 spattering. It was observed that the SV2 spattering of oil compositions comprising only SFAE (i.e. and no salt) salt was quite poor.

1. Edible fat continuous product comprising:
an overrun from 0 to 500%; and
from 7 to 30 wt. % of sucrose fatty acid ester having a HLB value from 2 to 7; and
from 0.5 to 5 wt. % of particulate anti-spattering agent, wherein said particulates are present at ambient storage conditions, but also when the product is heated, such as to 70 degrees Celsius.

2. Product according to claim 1, wherein the sucrose fatty acid ester has a HLB value from 2 to 5 and preferably from 2 to 4.

3. Product according to claim 1, comprising from 7.5 to 20 wt. %, preferably from 7.75 to 15 wt. %, more preferably from 8 to 11 wt. % and even more preferably from 8.5 to 10 wt. % of sucrose fatty acid ester.

4. Product according to claim 1, wherein the sucrose fatty acid ester comprises from 5 to 45 wt. %, preferably from 15 to 35 wt. %, more preferably from 16 to 32 wt. % and even more preferably from 17 to 25 wt. %, based on the total weight of the sucrose fatty acid ester, of sucrose mono-fatty acid ester.

5. Product according to claim 1, wherein the fatty acid moieties of the SFAE comprises at least 70 wt. %, based on the total weight of said moieties, of lauric acid, myristic acid, palmitic acid, stearic acid or mixtures thereof; preferably of palmitic acid, stearic acid or mixtures thereof; and more preferably of stearic acid.

6. Product according to claim 1, comprising an overrun from 10 to 400%, preferably from 20 to 300%, more preferably from 50 to 200% and even more preferably from 75 to 150%.

7. Product according to claim 1, comprising at least 75 wt. %, preferably at least 85 wt. % and more preferably at least 90 wt. % of liquid oil.

8. Product according to claim 1, comprising at most 25 wt. %, preferably at most 10 wt. %, more preferably at most 5 wt. %, even more preferably at most 2 wt. % and still even more preferably essentially no hardstock fat.

9. Product according to claim 1, wherein the particulate anti-spattering agent has an average volume weighted mean diameter from 10 nm to 10 mm, preferably from 20 nm to 5 mm and more preferably from 50 nm to 1 mm.

10. Product according to claim 1, wherein the particulate anti-spattering agents comprises or essentially consists of salt, porous powdered vegetable matter or a combination thereof; and preferably of sodium chloride, potassium chloride, soy flour or a combination thereof.

11. Product according to claim 1, comprising from 0.10 to 4 wt. %, preferably from 0.5 to 3.5 wt. %, more preferably from 1.0 to 3.0 wt. % and even more preferably from 1.5 to 2.5 wt. % of total particulate anti-spattering agent.

12. Product according to claim 1, comprising at most 15 wt. %, preferably at most 5 wt. %, more preferably at most 2 wt. % of water-phase and even more preferably comprises essentially no water-phase.

13. Product according to claim 1, wherein the product has a Stevens value at 5 degrees Celsius from 25 to 250, preferably from 35 to 200, more preferably from 35 to 175 and even more preferably from 50 to 100.

14. A method for preparation of an edible product according to claim 1, comprising the steps:
a) providing a liquid mixture of fat; and sucrose fatty acid ester having a HLB value from 2 to 7 at a concentration from 7 to 30 wt. %; and
b) optionally aerating the liquid mixture of step a) to an overrun from 0 to 500%; wherein the 0.01 to 5 wt. % of the particulate anti-spattering agent can be added before, during or after step a) or b) in whole or in parts.

15. Use of a product according to claim 1 or obtained by the process according to claim 14 for reducing spattering during shallow frying and preferably for reducing secondary spattering.
